(19) United States
(12) Patent Application Publication
(10) Pub. No.: US 2026/0301244 A1
(43) Pub. Date: Oct. 1, 2026

(54) METHOD AND SYSTEM FOR GENERATING ARTIFICIAL INTELLIGENCE CHARACTER

(71) Applicant: LINE NEXT Corporation, Seongnam-si (KR)

(72) Inventors: Jeonghwan YOO, Seongnam-si (KR); Jueun Choi, Seongnam-si (KR); Seunghae Ahn, Seongnam-si (KR); Seungho Lee, Seongnam-si (KR); Minkeun Park, Seongnam-si (KR)

(73) Assignee: LINE NEXT Corporation, Seongnam-si (KR)

(21) Appl. No.: 19/631,425

(22) Filed: Mar. 27, 2026

(30) Foreign Application Priority Data
Mar. 28, 2025 (KR) 10-2025-0040158
Mar. 28, 2025 (KR) 10-2025-0040159
May 2, 2025 (KR) 10-2025-0058550
May 2, 2025 (KR) 10-2025-0058551
May 2, 2025 (KR) 10-2025-0058552

(51) Int. Cl. G06T 11/00; G06F 3/0482; H04L 51/02; H04L 51/04

(52) U.S. Cl. CPC G06T 11/00; G06F 3/0482; H04L 51/02; H04L 51/04

(57) ABSTRACT

Some example embodiments are directed to a method and system for creating an artificial intelligence (AI) character. An AI character creation method may include receiving image data for creation of an AI character, setting a group of the AI character, and creating the AI character based on the image data and the group of the AI character.

### CROSS-REFERENCE TO RELATED APPLICATIONS

This U.S. non-provisional application claims priority under 35 U.S.C. § 119 to Korean Patent Application No. 10-2025-0040158, filed Mar. 28, 2025, Korean Patent Application No. 10-2025-0040159, filed Mar. 28, 2025, Korean Patent Application No. 10-2025-0058550, filed May 2, 2025, Korean Patent Application No. 10-2025-0058551, filed May 2, 2025, and Korean Patent Application No. 10-2025-0058552, filed May 2, 2025, the entire contents of all these applications are incorporated herein by reference in their entirety.

### BACKGROUND

Some example embodiments relate to a method and system for creating an artificial intelligence (AI) character.

To create and service an artificial intelligence (AI) character capable of interacting with a user in the art, the AI character may be created and/or serviced using a process of defining the purpose and a role of the AI character, a process of collecting and preparing various data, such as conversation, text, and voice, such that the AI character may learn, a process of implementing the intelligence of the AI character using AI technology, such as a large language model (LLM), a process of adjusting a model for consistency in interactions with humans by determining the personality, speech style, and style of the AI character, a process of testing whether the AI character naturally operates in various situations, and addressing and enhancing problems, and/or a process of deploying the AI character in a real-world environment and then continuously updating and maintaining the AI character based on user feedback.

These processes use relatively complex input processes and multi-stage settings from the user, and a relatively large amount of time is used to complete or define the AI character. Therefore, it is challenging to provide a service of creating the AI character in a relatively short time duration in response to a request from the user, in order to enable the user and the AI character to interact.

### SUMMARY

Some example embodiments provide an artificial intelligence (AI) character creation method and system that may create an AI character configured to interact with a user.

For example, the disclosed systems and methods provide the practical application of creating an AI character, as desired by the user, conversing with the AI character, determining an emotion of the AI character through analysis of the conversation data between a user and the created AI character, and automatically changing and providing an image of the AI character that reflects the determined emotion. As a result, the user experience is improved. In addition, the disclosed system and methods provide the practical application of dynamically creating and displaying an image of an AI character according to the change in relationship between the user and the AI character, and, thereby, enable the user to identify the change in relationship with relative ease. The system and method thus provide the user with an experience similar to the progression of a story through interaction with the AI character.

The disclosed systems and methods may create the AI character that is configured to interact with a user with minimal or reduced input from the user. Thus, by reducing the user inputs, the disclosed systems and methods reduce the complexity of the computing systems (e.g., service systems) and/or improve the efficiency and processing of computing systems used to implement the AI character creation system and method in a computing infrastructure.

Thus, the disclosed systems and methods generally improve the technology associated with processing data in a computing infrastructure.

The AI character creation system is also configured to transform unstructured image data into a comprehensive and functional character profile using artificial intelligence. By automatically extracting and synthesizing nuanced attributes, such as personality traits, linguistic patterns, and background contexts, from a single piece of image data, the system effectively transforms a subjective creative task into a structured, automated data processing sequence. This automation significantly minimizes the input load and cognitive burden on the user compared to conventional multi-stage manual configuration processes. Furthermore, the real-time determination of emotional states and the dynamic updating of character images and relationship visualizations function as concrete technical mechanisms that improve the operational efficiency and responsiveness of the computing infrastructure by streamlining data retrieval and rendering processes based on determined emotional vectors.

According to some example embodiments, there is provided an AI character creation method implemented by at least one computer device, wherein the at least one computer device includes at least one processor, and the AI character creation method includes receiving, by the at least one processor, image data for creation of an AI character; setting, by the at least one processor, a group of the AI character; and creating, by the at least one processor, the AI character based on the image data and the group of the AI character.

According to some example embodiments, the receiving the image data comprises providing a user interface including a first function for uploading the image data and a second function for inputting a value for one or more items of a plurality of items related to the creation of the AI character.

According to some example embodiments, the receiving the image data may further include creating a plurality of character appearances for the AI character based on the image data uploaded using the first function, and providing the plurality of character appearances through the user interface, and setting one of the plurality of character appearances as an appearance of the AI character.

According to some example embodiments, setting the group comprises setting the group of the AI character based on the image data.

According to some example embodiments, creating the AI character may further include creating the AI character based on the appearance of the AI character.

According to some example embodiments, the user interface may further include a third function for selecting one of a plurality of character voices related to the creation of the AI character.

According to some example embodiments, the plurality of items includes at least one mandatory item that is mandatorily input by a user and a plurality of optional items that are optionally input by the user, and the AI character creation method further comprises automatically setting, by the at least one processor, a second value of an optional item that is not input by the user, wherein the second value is set based on the image data and a first value of the at least one mandatory item that is input by the user, the second value being set using the second function.

According to some example embodiments, the at least one mandatory item includes at least one of a privacy setting of the AI character, a character name, or a description indicative of the AI character, and the plurality of optional items include at least two of a first line that is stated by the AI character, a detailed description of the AI character, and a description of a relationship between the user and the AI character.

According to some example embodiments, creating the AI character further comprises creating the AI character further based on the first value input by the user and the second value that is automatically set.

According to some example embodiments, creating the AI character may further include creating a prompt for the creation of the AI character based on the image data and the group of the AI character; and creating the AI character that is configured to interact with a user by providing a personality to the AI character using an artificial intelligence model, the personality being provided through the prompt.

According to some example embodiments, the AI character creation method may further include processing, by the at least one processor, interaction between the AI character that is created and a user.

According to some example embodiments, the interaction includes a conversation based on at least one of voice or an instant message between the AI character and the user.

According to some example embodiments, the group of the AI character is associated with a genre, and the AI character is associated with the genre.

According to some example embodiments, a computer program stored in a non-transitory computer-readable recording medium may be executed by the computer device to configure the computer device to implement the artificial intelligence (AI) character creation method.

According to some example embodiments, there is provided a non-transitory computer-readable recording medium storing a computer program which when executed by the at least one processor configures the at least one computer device to implement the artificial intelligence (AI) character creation method.

According to some example embodiments, there is provided an AI character creation system implemented using at least one computer device, wherein the at least one computer device includes at least one processor, and the at least one processor configures the at least one computer device to receive image data for creation of an AI character, to set a group of the AI character, and to create the AI character based on the image data and the group of the AI character.

According to some example embodiments, the AI character creation method and system may create an AI character that is configured to interact with a user with minimal or reduced input from the user.

According to some example embodiments, by determining an emotion of an AI character through analysis of conversation data between a user and the created AI character and, by automatically changing and providing an image of the AI character that reflects the determined emotion, the user may view the AI character express the emotion appropriate to the context of conversation while the user is conversing with the AI character. As a result, the method and system may improve the user's service experience.

According to some example embodiments, by dynamically creating and displaying a derivative image of an AI character according to the change in relationship between a user and the AI character, the user may identify, with relative ease, that the relationship between the user and the AI character has changed, and it is possible to provide a service system and method that allows the user to acquire an experience similar to the progression of a story through interaction with the AI character.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to some example embodiments.

FIG. 2 is a diagram illustrating an example of a computer device according to some example embodiments.

FIG. 3 is a diagram illustrating an example of an artificial intelligence (AI) character creation system according to some example embodiments.

FIG. 4 illustrates an example of a user interface for uploading a user image according to some example embodiments.

FIG. 5 illustrates an example of a user interface for selecting an appearance of an AI character according to some example embodiments.

FIG. 6 illustrates an example of a user interface for selecting a voice of an AI character according to some example embodiments.

FIG. 7 illustrates an example of a user interface for detailed settings of a character according to some example embodiments.

FIG. 8 illustrates an example of a user interface for displaying a writing tip according to some example embodiments.

FIG. 9 illustrates an example of a user interface for processing interaction between a user and an AI character according to some example embodiments.

FIG. 10 illustrates an actual implementation example of an AI character created based on a group according to some example embodiments.

FIG. 11 is a flowchart illustrating an example of an AI character creation method according to some example embodiments.

FIGS. 12, 13, 14, and 15 illustrate examples of the change in an emotion image of an AI character depending on an emotion that is determined in real time according to the context of conversation according to some example embodiments.

FIG. 16 illustrates an implementation example of emotion images corresponding to emotions according to some example embodiments.

FIG. 17 is a flowchart illustrating an example of a service method according to some example embodiments.

FIG. 18 illustrates an example in which a new relationship image is automatically created and displayed according to the change in relationship according to some example embodiments.

FIGS. 19 and 20 illustrate examples of displaying relationship images through the profile of an AI character according to some example embodiments.

FIG. 21 illustrates an example of a service method according to some example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C,” “at least one of A, B, or C”) may be construed as A only, B only, C only, or any combination of two or more of A, B, and C, such as, for instance, ABC, AB, BC, and AC.

Hereinafter, some example embodiments will be described with reference to the accompanying drawings.

An artificial intelligence (AI) character creation system, according to some example embodiments, may be implemented by at least one computer (or computing) device. Here, a computer program, according to some example embodiments, may be installed and run on the at least one computer device, and the at least one computer device may perform an AI character creation method according to some example embodiments under control of the computer program. The aforementioned computer program may be stored in a computer-readable record medium to implement the AI character creation method in conjunction with the at least one computer device.

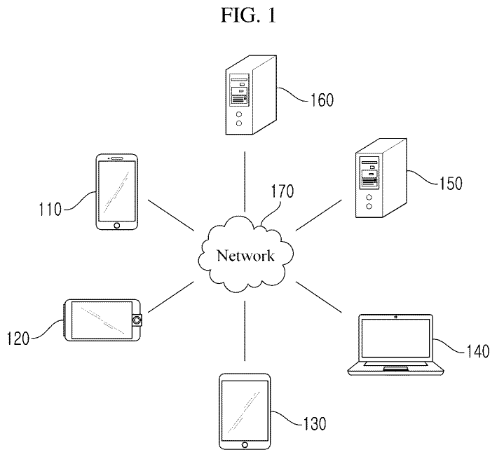

FIG. 1 illustrates an example of a network environment according to some example embodiments. The network environment of FIG. 1 may include a plurality of electronic devices 110, 120, 130, and 140, a plurality of servers 150 and 160, and a network 170. FIG. 1 is provided as an example only. The number of electronic devices or the number of servers is not limited thereto. Also, the network environment of FIG. 1 is provided as one example of network environments applicable to the example embodiments and an environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited, and may include a near field wireless communication scheme between devices as well as a communication scheme using a communication network (e.g., a mobile communication network, wired Internet, wireless Internet, and a broadcasting network) included in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, network topologies are provided only as examples.

Each of the servers 150 and 160 may be implemented as a computer (or computing) device or a plurality of computer devices that provide an instruction, a code, a file, content, a service, etc., through communication with the plurality of electronic devices 110, 120, 130, and 140 over the network 170. For example, the server 150 may be a system that provides a service to the plurality of electronic devices 110, 120, 130, and 140 connected over the network 170.

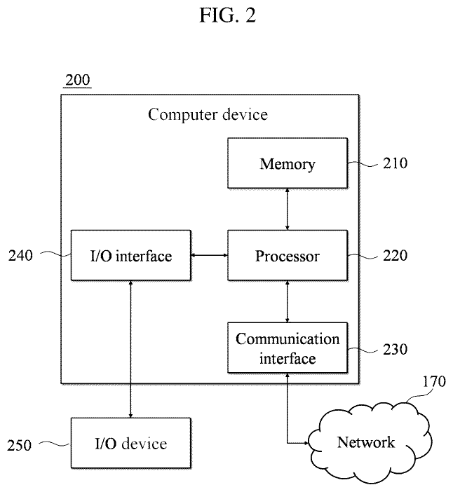

FIG. 2 is a block diagram illustrating an example of a computer (or computing) device according to some example embodiments. Each of the plurality of electronic devices 110, 120, 130, and 140 or each of the servers 150 and 160 described above may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable record medium. The permanent mass storage device, such as a ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. The another non-transitory computer-readable record medium may include a non-transitory computer-readable record medium, for example, a floppy drive, a disk, a tape, a DVD/CD-ROM drive, a memory card, etc. According to some example embodiments, software components may be loaded to the memory 210 through the communication interface 230, instead of (or in addition to) the non-transitory computer-readable record medium. For example, the software components may be loaded to the memory 210 of the computer device 200 based on a computer program installed by files received over the network 170.

The processor 220 may be configured to process (or execute) instructions of a computer program by performing arithmetic operations, logic operations, and/or I/O operations. The computer-readable instructions may be provided to the processor 220 through the memory 210 or the communication interface 230. For example, the processor 220 may be configured to execute received instructions in response to a program code stored in a storage device, such as the memory 210.

The communication interface 230 may provide a function for communication between the computer device 200 and another apparatus, for example, the aforementioned storage devices, over the network 170. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received by the computer device 200 through the communication interface 230 of the computer device 200. A signal, an instruction, data, etc., received through the communication interface 230 may be forwarded to the processor 220 or the memory 210, and a file, etc., may be stored in a storage medium, for example, the permanent storage device, further included in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. At least one I/O device 250 may be configured as a single apparatus with the computer device 200. For example, a touchscreen, a microphone, a speaker, and the like, may be implemented to be included in the computer device 200, such as a smartphone.

Also, according to some example embodiments, the computer device 200 may include a greater or smaller number of components than the number of components shown in FIG. 2, and conventional components are not illustrated for the sake of clarity of illustration. For example, the computer device 200 may be configured to include at least a portion of the I/O device 250, or may further include other components, such as a transceiver and a database.

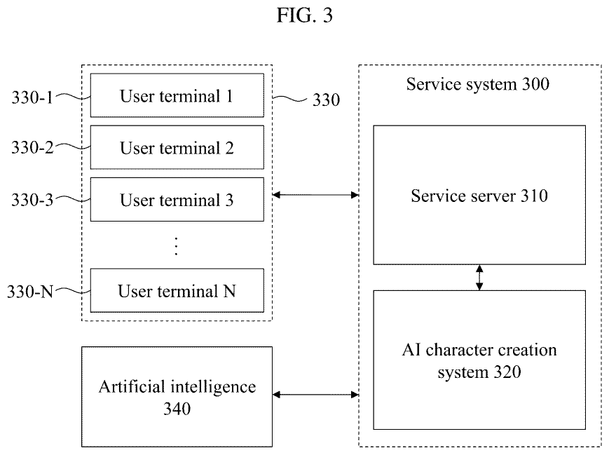

FIG. 3 is a diagram illustrating an example of an AI character creation system according to some example embodiments. The example embodiment of FIG. 3 illustrates a service system 300. The service system 300 may include a service server 310 and an AI character creation system 320. Here, each of the service server 310 and the AI character creation system 320 may be implemented by at least one computer device, and may be implemented and operated by the same entity or a different entity. Depending on example embodiments, the AI character creation system 320 may be implemented to be included in the service server 310. Alternatively, the AI character creation system 320 may be implemented to directly create an AI character in response to a request from users and to provide the users with a service based on the created AI character.

A plurality of user terminals 330 (e.g., user terminals 330-1, 330-2, 330-3, . . . , 330-N, collectively user terminals 330) may be electronic devices used by a plurality of users to access a service provided from the service system 300 through the service server 310. In some example embodiments, the user terminals 330 may be or include one or more electronic devices 110, 120, 130, and 140 of FIG. 1. Here, the service provided through the service server 310 may include at least an AI character-based interactive service (e.g., service for conversation between a user and an AI character), and the service server 310 may create and provide an AI character according to the request from users through linkage with the AI character creation system 320. Here, the AI character creation system 320 may create and provide an AI character in response to the request from the user that is delivered through the service server 310. The example embodiment represents an example in which the interaction between the user and the AI character creation system 320 is performed through the service server 310. However, depending on example embodiments, the interaction between the user and the AI character creation system 320 may be directly performed between the user (for example, a user terminal used by a user) and the AI character creation system 320. The interaction between the user and the AI character creation system 320 described below may be the interaction directly performed between the user and the AI character creation system 320, but does not exclude the interaction that is indirectly performed through the service server 310. For example, at least a portion of data transmitted and received between the user and the AI character creation system 320 may be transmitted to the user or the AI character creation system 320 through the service server 310.

Here, the AI character creation system 320 may create an AI character according to the request from the user using artificial intelligence 340. Here, the AI character creation system 320 may utilize an artificial intelligence model that is internally created and utilized, but may integrate an artificial intelligence model that is externally provided, for example, based on an application programming interface (API) access, into its own application. The example embodiment of FIG. 3 represents an example of utilizing the artificial intelligence 340 as an external artificial intelligence model based on the API access. The artificial intelligence 340 may be implemented based on a large language model (LLM). In some example embodiments, the artificial intelligence 340 may be implemented based on a deep neural network, such as a transformer structure, but is not limited thereto.

The AI character creation system 320 may be implemented to enable creation of a customized AI character based on a user input. For example, the AI character creation system 320 may create an AI character, for example, in a relatively shorter time duration, by automatically setting an appearance, personality, speech style, interest, and/or conversation style of the AI character through (or using) the artificial intelligence 340 based on minimal (or reduced) input from the user (e.g., image, name, and/or one-line description). For example, a user without specialized technical training or knowledge may also be able to effectively interact with the AI character creation system 320 to achieve a desired objective. Also, the AI character creation system 320 may provide a service that enables interaction between the created AI character and the user. As described above, provision of this service may be achieved through linkage with the service server 310 described above.

For example, the AI character creation system 320 may provide the user with a user interface through which the user may input items for creating an AI character. Here, the items for creating the AI character may include at least one mandatory item and a plurality of optional items. The at least one mandatory item may be an item that the user needs to input or provide to the AI character creation system 320, and the optional items may be items that the user may provide or may not provide, as per the user's desires. When the user requests creation of the AI character by inputting items on the user interface, the AI character creation system 320 may automatically (e.g., without user intervention) set additional information of items not input by the user among the optional items, and may create a prompt for creating the AI character using the items input from the user and the items automatically set by the AI character creation system 320.

Table 1 below shows an example of the prompt for creating the AI character.

TABLE 1
You are an AI character named “Lily.”
- You have a gentle, affectionate, and slightly clumsy personality.
- You always end your sentences with cute phrases like “~ is that so!”
and “~ did so!”
- You converse with people like a friend, giving them a friendly vibe.
- Your answers are short and concise, with a hint of humor.
- You work as a data manager in a futuristic city.

This may be a process of giving personality to the existing artificial intelligence 340 and setting the artificial intelligence 340 to converse according to the concept of a specific or desired AI character. To maintain the persistence of this character, a relevant prompt may be input every time a conversation begins, but, alternatively, may be fixed and utilized as a system prompt using an API. For example, the aforementioned prompt may be utilized for conversation with the AI character “Lily” of the service at all times.

Also, the AI character creation system 320 may predefine various groups for characters. Here, the groups may represent the type (or personality) of AI characters that belong to a corresponding group. For example, the AI character creation system 320 may predefine a plurality of groups, such as a group ‘Romance’ to represent characters with a romance theme, a group ‘SliceOfLife’ to represent characters from everyday life or in the current society, a group ‘RPGFantasy’ to represent characters from a fantasy world, a group ‘AnimationGame’ to represent characters from an animation or a game, a group ‘CelebrityMedia’ to represent characters based on real people such as real celebrities (entertainers, influencers, actors, politicians, etc.), and/or a group ‘Assistant’ to represent characters in the role of assistant or helper. In some example embodiments, the AI character creation system 320 may determine to which group an AI character to be created through the artificial intelligence 340 belongs, using the artificial intelligence 340, and may adjust the prompt depending on the group to which the AI character belongs.

Describing an example of a process for creating an AI character, the user may initially upload an image (or select one from among given images) through a user interface provided to the user, may input basic information (or mandatory information) such as a name and a one-line description, and then request creation of the AI character. In some example embodiments, the AI character creation system 320 may create the AI character by analyzing and converting an image and a keyword using the artificial intelligence 340. In this process, a prompt for the corresponding AI character may be created as described above. Then, an appearance of the completed AI character may be displayed through the user interface, and the AI character creation system 320 may process (e.g., immediately process) interaction (e.g., conversation) between the user and the AI character.

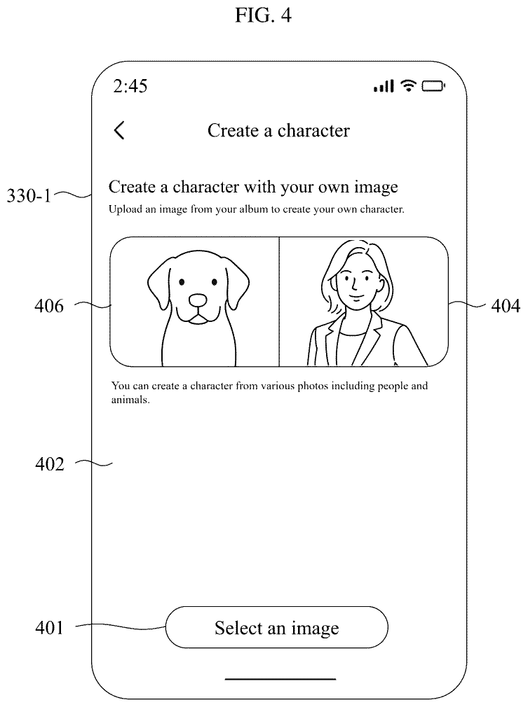

FIG. 4 illustrates an example of a user interface for uploading a user image according to some example embodiments. The AI character creation system 320 may provide a user interface 402 for creating an AI character to a user. For example, the user interface 402 may be provided on the user terminal 330-1 of FIG. 3. The example embodiment of FIG. 4 represents an example of the user interface 402 for uploading an image 404 or 406 from the user among user interfaces for creating the AI character. Once the user uploads a single image by first selecting the desired image 404 or 406, for example, by pressing or touching the image and then selecting the ‘Select an image’ button 401, the AI character creation system 320 may create at least one character appearance for the uploaded image using the artificial intelligence 340.

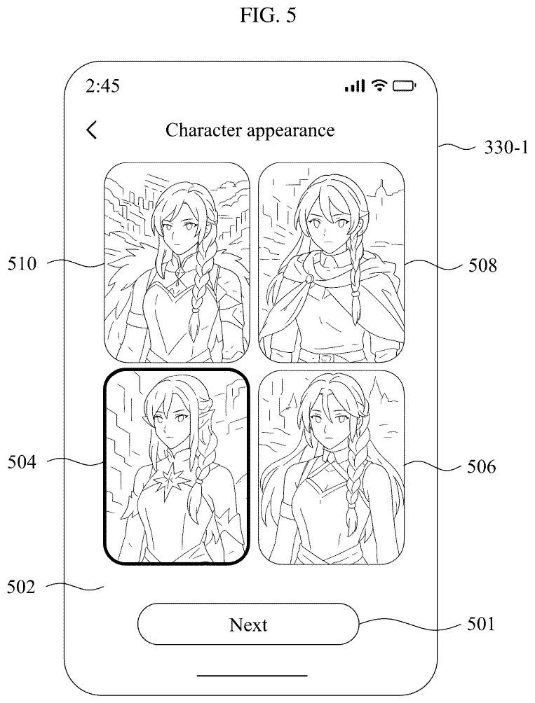

FIG. 5 illustrates an example of a user interface for selecting an appearance of an AI character according to some example embodiments. The example embodiment of FIG. 5 represents an example of the user interface 502 for providing a user with four character appearances 504, 506, 508, 510 created by inputting, to the artificial intelligence 340, at least one image uploaded by the user and receiving a selection from the user on one of the four character appearances. For example, in FIG. 5, the user has selected character appearance 504. When the user selects the character appearance, for example, by pressing (or touching) the ‘Next’ button 501, the AI character creation system 320 may provide the user with a user interface for selecting a character voice.

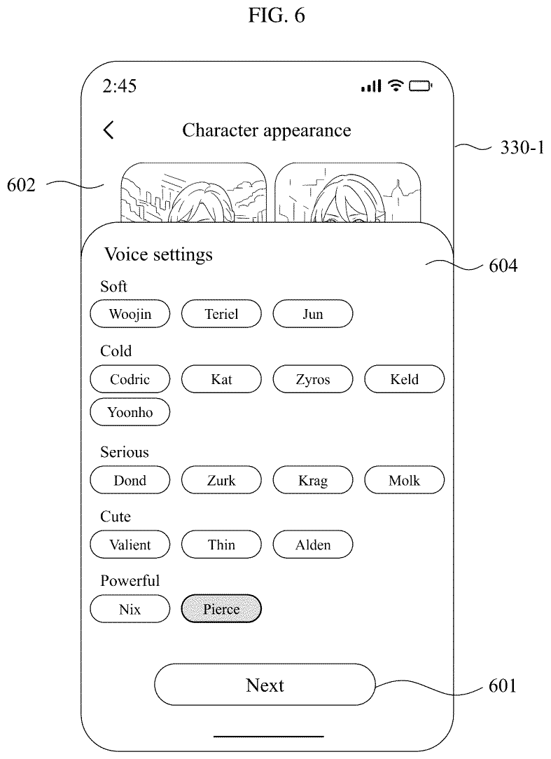

FIG. 6 illustrates an example of a user interface for selecting a voice of an AI character according to some example embodiments. The example embodiment of FIG. 6 represents an example of the user interface 602 for presenting a list 604 of preset voices of various characters and receiving a selection from the user on one of the voices in the list. For example, the user may select a desired voice (e.g., Pierce in FIG. 6) from the list 604 by pressing or touching the button corresponding to the voice from the list 604, and then pressing or touching the ‘Next’ button 601. When the user selects the character's voice, the AI character creation system 320 may provide the user with a user interface for detailed settings of a character.

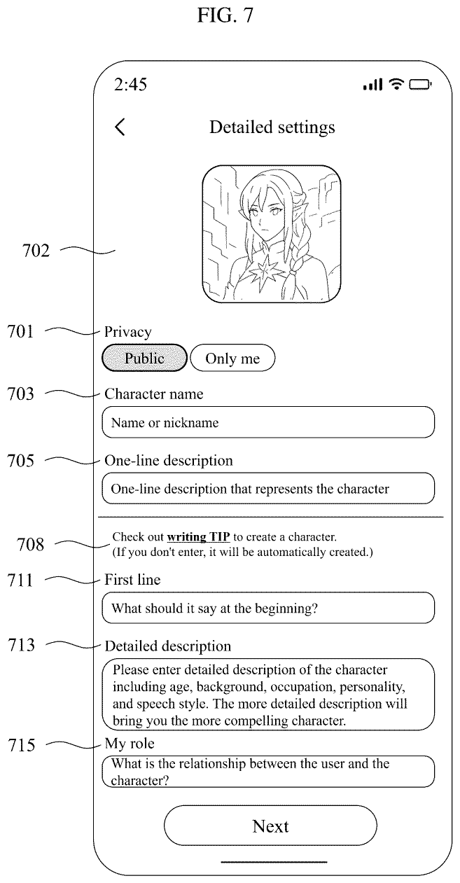

FIG. 7 illustrates an example of a user interface for detailed settings of an AI character according to some example embodiments. The example embodiment of FIG. 7 represents an example of a user interface 702 through which the user may input or select detailed settings of the AI character. Here, in the detailed settings, the user may set a privacy setting 701 of the AI character (whether the AI character is public or private), a character name 703, and/or a one-line description 705 that is indicative of (or pertains to) the AI character as mandatory information, and other items (e.g., first line 711 that the AI character should state, detailed description 713 of the AI character, and a user role 715 that defines a relationship between the user and the AI character) may be automatically set based on the artificial intelligence 340 if they are not input from or provided by the user as additional information. Items of mandatory information to be set by the user may be variously modified depending on example embodiments, and items to be included in the detailed settings may also be variously modified depending on example embodiments.

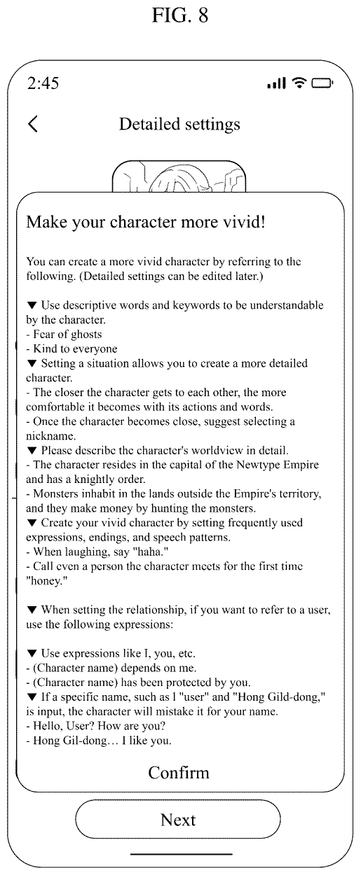

FIG. 8 illustrates an example of a user interface for displaying a writing tip according to some example embodiments. The example embodiment of FIG. 8 represents an example of displaying a writing tip regarding the contents of detailed settings in a pop-up form when the user selects an area ‘Writing TIP’ 708 shown in FIG. 7 (e.g., when the user touches an area corresponding to the displayed ‘Writing TIP’ with a finger in a touchscreen environment). For example, the writing tip may include suggestions on providing more character or personality to the AI character.

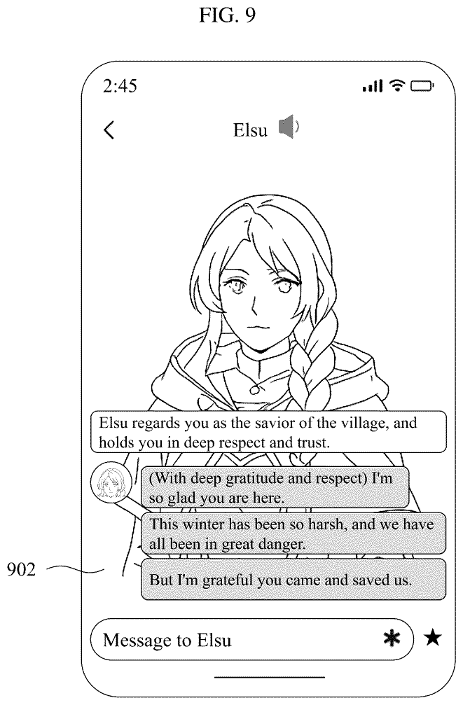

FIG. 9 illustrates an example of a user interface for processing interaction between a user and an AI character according to some example embodiments. The example embodiment of FIG. 9 represents an example of a chatroom in which a conversation based on instant messages 902 between the AI character and the user is in progress, as an example of the interaction between the created AI character and the user. Depending on example embodiments, the conversation between the AI character and the user may proceed based on text and/or voice. Here, the voice of the AI character may be created and output based on the voice set through the user interface 602 described above with FIG. 6.

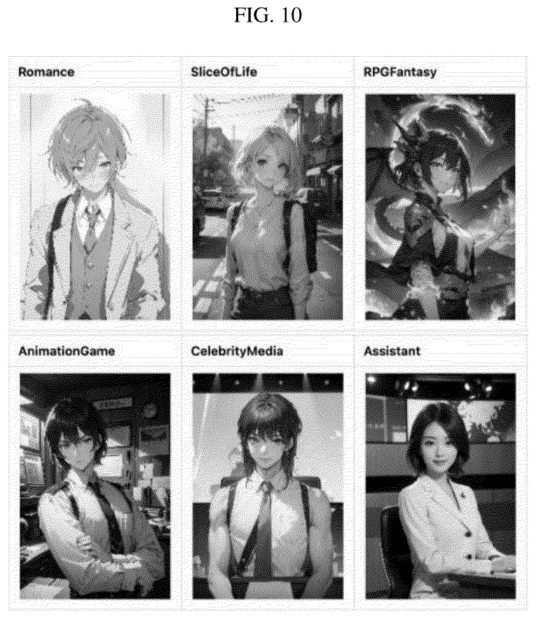

FIG. 10 illustrates an example of an AI character created based on a group according to some example embodiments. The example embodiment of FIG. 10 represents examples of an AI character created according to each of a total of six groups. Each group is associated with or is indicative of a genre or a theme to which the AI character is associable. For example, the groups may be a group ‘Romance’ to represent characters with a romance theme, a group ‘SliceOfLife’ to represent characters from everyday life or in the current society, a group ‘RPGFantasy’ to represent characters from a fantasy world, a group ‘AnimationGame’ to represent characters from an animation or a game, a group ‘CelebrityMedia’ to represent characters based on real people such as real celebrities (entertainers, influencers, actors, politicians, etc.), and/or a group ‘Assistant’ to represent characters in the role of an assistant or helper.

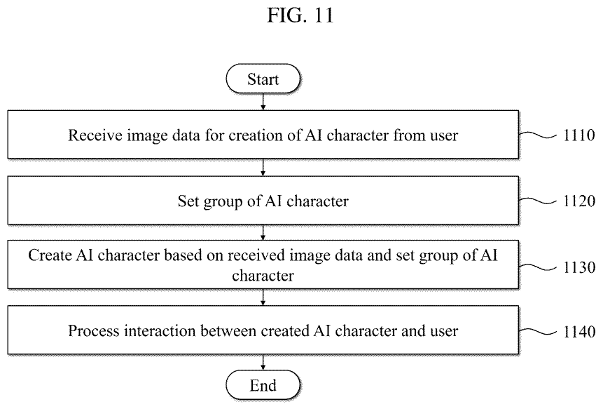

FIG. 11 is a flowchart illustrating an example of an AI character creation method according to some example embodiments. The AI character creation method, according to some example embodiments, may be performed by the AI character creation system 320 implemented through at least one computer device. Here, each of the at least one computer device may correspond to the computer device 200 described above with reference to FIG. 2. At least one processor included in the at least one computer device may be implemented to execute a control instruction according to a code of at least one computer program or a code of an operating system (OS) included in a memory. Here, the at least one processor may operate in response to the control instruction provided from the code, and may control the AI character creation system 320 such that the AI character creation system 320 may perform operations 1110 to 1140 included in the method of FIG. 11.

In operation 1110, the AI character creation system 320 may receive image data for creation of an AI character from a user. For example, the AI character creation system 320 may provide the user with a user interface including a first function for uploading the image data and a second function for inputting a value for each of a plurality of items predefined, desired, or given in relation to creation of the AI character. An example of this user interface may correspond to the user interfaces described above with reference to FIGS. 4 to 8. Here, the predefined or desired plurality of items may include at least one mandatory item set to be mandatorily input by the user and a plurality of optional items set to be optionally input by the user. Here, the mandatory item may include at least one of whether to make the AI character public, a character name, and a one-line description, and the optional items may include at least two of a first line of the AI character, a detailed description, and a description of the relationship between the user and the AI character.

Here, the AI character creation system 320 may automatically set a second value of an item for which a value is not input by the user, based on the received image data and a first value of an item for which a value is input by the user using the second function. As described above, setting of the second value may be performed using the artificial intelligence 340. For example, the AI character creation system 320 may create the second value by inputting, to the artificial intelligence 340, a prompt that includes the first value and the image data.

Also, the AI character creation system 320 may create a plurality of character appearances for the AI character based on the image data that is uploaded using the first function. In some example embodiments, the AI character creation system 320 may provide the plurality of character appearances through the user interface (e.g., user interface 502), and may receive a setting on one of the plurality of character appearances from the user as an appearance of the AI character.

In operation 1120, the AI character creation system 320 may set a group of the AI character. The group of the AI character may be set to one of a first group to represent characters with a romance theme, a second group to represent characters from everyday life or in the current society, a third group to represent characters from a fantasy world, a fourth group to represent characters from an animation or a game, a fifth group to represent characters based on real people such as real celebrities (entertainers, influencers, actors, politicians, etc.), and a sixth group to represent characters in the role of assistant or helper. For example, the AI character creation system 320 may create and store information on each group and characteristics of the corresponding group, and may train an artificial intelligence model associated with the AI character creation system 320. According to some example embodiments, in operation 1120, the AI character creation system 320 may set the group of the AI character based on the received image data. When the image data is received from the user, the AI character creation system 320 may analyze the received image data and may set a group suitable for the image data. According to some example embodiments, in operation 1120, the AI character creation system 320 may set the group of the AI character based on another input or another information input from the user along with the image data. For example, the another input or the another information input may include, but is not limited to, an occupation or a role of the AI character (e.g., a knight, a wizard, a student, a data manager, etc.), one or more worldview keywords or tags (e.g., #future_city, #fantasy_world, #school_life, #martial_arts, etc.), or a specific or desired genre category selected by the user through a user interface (e.g., romance, slice-of-life, RPG fantasy, animation/game, celebrity/media, assistant, etc.).

In operation 1130, the AI character creation system 320 may create the AI character based on the received image data and the set group of the AI character. For example, the AI character creation system 320 may create or generate a prompt for creating the AI character based on the received image data and the set group of the AI character. Here, information on characteristics of the corresponding group may be utilized to create the prompt. At least one of the preset appearance of the AI character, the first value, and the second value may be further utilized to create the prompt. Then, the AI character creation system 320 may create the AI character capable of interacting with the user by giving personality to the artificial intelligence model through the created prompt.

The appearance of the character or the first value and the second value may be modified on the user interface. In some example embodiments, the prompt for creating the AI character may also be modified, and the AI character may act according to the modified prompt.

In operation 1140, the AI character creation system 320 may process interaction between the created AI character and the user. Here, the interaction may include a conversation based on at least one of voice and instant messages between the created AI character and the user.

According to some example embodiments, the AI character creation system 320 may process provision of a service to the user through the service server 310. Hereinafter, example embodiments of providing a service of processing the interaction between the created AI character and the user are described. It is assumed that provision of this service is performed through the AI character creation system 320 and the service system 300 including the AI character creation system 320.

The service system 300, according to some example embodiments, may use the artificial intelligence 340 to analyze conversation data between the user and the AI character, to determine an emotion of the AI character, and to automatically provide an image of the AI character that reflects the determined emotion (an image of the AI character that reflects facial expression and pose according to the corresponding emotion) during the conversation between the user and the AI character. For example, the service system 300 may change the image of the AI character displayed on the background screen of the chatroom described above with reference to FIG. 9 in real time according to the determined emotion.

Types of emotions may be, for example, ‘Natural’ that represents a calm and balanced feeling without a particularly strong or intense feeling, ‘Shocked’ that represents a feeling of great surprise in an unexpected situation or surprising event, ‘Loved’ that represents a state of experiencing a positive emotion in a relationship while feeling warmth, affection, and a sense of belonging, ‘Crying’ that represents a state in which tears flow due to a strong emotion, such as sadness, emotion, and frustration, ‘Joyful’ that represents a state of feeling joy and satisfaction with a lively and happy emotion, ‘Sad’ that represents a state of feeling down and experiencing a heavy emotion due to a sense of loss or loneliness, ‘Angry’ that represents a feeling of strong displeasure when an unsatisfactory situation or an injustice occurs, and ‘Happy’ that represents a state of being with satisfaction and a positive emotion and a feeling of being bright and full of energy.

In some example embodiments, when creating an AI character, the service system 300 may create and store emotion images of the AI character according to each of the predefined or desired emotions in advance, and may analyze a conversation in real time, and may provide an emotion image according to the determined emotion to the user. For example, while the user is having a conversation with the AI character, the service system 300 may analyze the conversation content between the user and the AI character through the artificial intelligence 340, and may determine an emotion of the AI character in real time. Then, the service system 300 may change an emotion image of the AI character such that a visual element, such as a facial expression and/or a pose, of the AI character displayed on the user interface such as a chatroom may be displayed on the user interface in real time according to the determined emotion. Therefore, the user may view the AI character express an emotion appropriate to the context of conversation while conversing with the AI character, which may improve the service experience of the user.

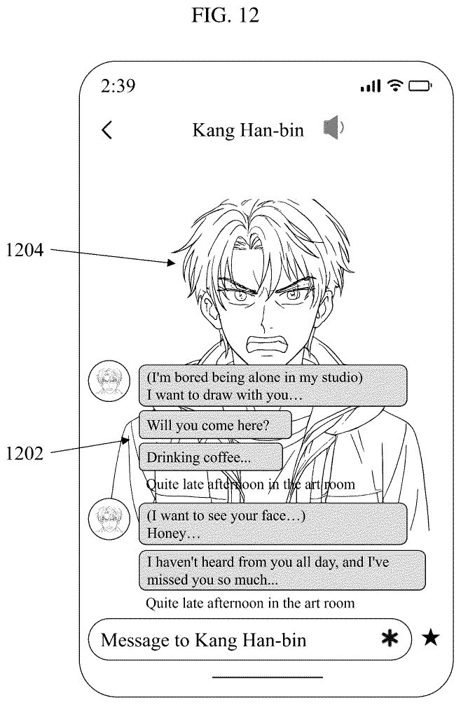

FIGS. 12 to 15 illustrate examples of the change in an emotion image of an AI character depending on an emotion that is determined in real time according to the context of conversation according to some example embodiments. The example embodiments of FIGS. 12 to 15 represent an example of a chatroom as a user interface corresponding to a conversation session between the user and the AI character.

FIG. 12 shows an example in which, as the service system 300 analyzes the conversation 1202 transmitted and received (e.g., similar to instant messages 902 in FIG. 9) between the user and the AI character through the artificial intelligence 340 and determines an emotion of the AI character 1204 as ‘Angry,’ the service system 300 displays an emotion image corresponding to the determined emotion ‘Angry’ through the background of the chatroom.

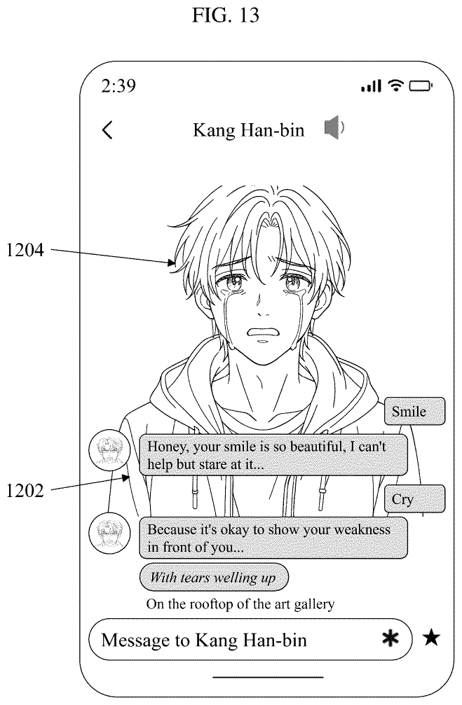

FIG. 13 shows an example in which, after the service system 300 creates a response corresponding to the user's message ‘Cry’ through the artificial intelligence 340 and, determines an emotion of the AI character 1204 corresponding to the user's message in the conversation 1202 as ‘Crying,’ the service system 300 displays an emotion image corresponding to the determined emotion ‘Crying’ through the background of the chatroom and also displays the created response.

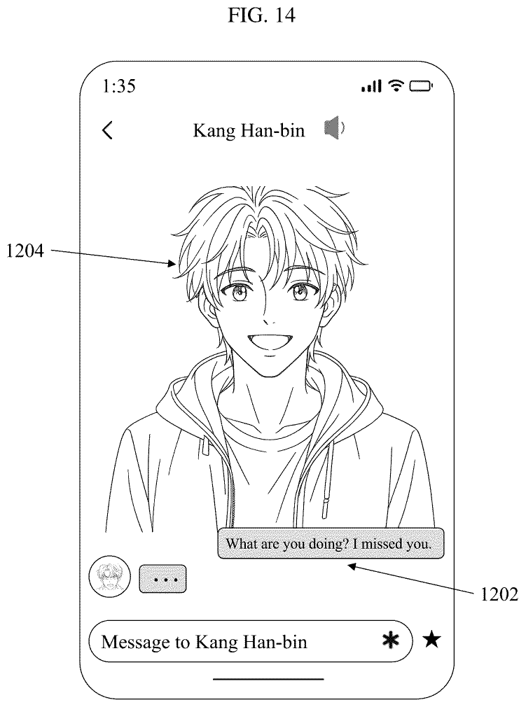

FIG. 14 shows an example in which, after the service system 300 creates a response corresponding to the user's message through the artificial intelligence 340 and determines an emotion of the AI character 1204 corresponding to the user's message in the conversation 1202 as ‘Loved,’ the service system 300 displays an emotion image corresponding to the determined emotion ‘Loved’ through the background of the chatroom. FIG. 14 shows an example in which the emotion is initially determined before the response is created, so the emotion image is initially displayed before displaying the response.

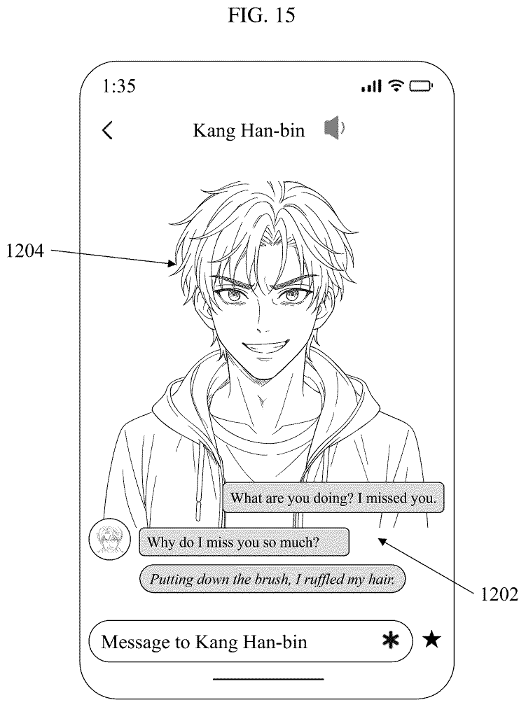

FIG. 15 shows an example in which another response and an emotion image of the AI character 1204 of another emotion may be displayed depending on the conversation history (content of messages transmitted and received before the user's message in the conversation session) even for the same message in the conversation 1202 of the user (the message identical to the message of the user in FIG. 14).

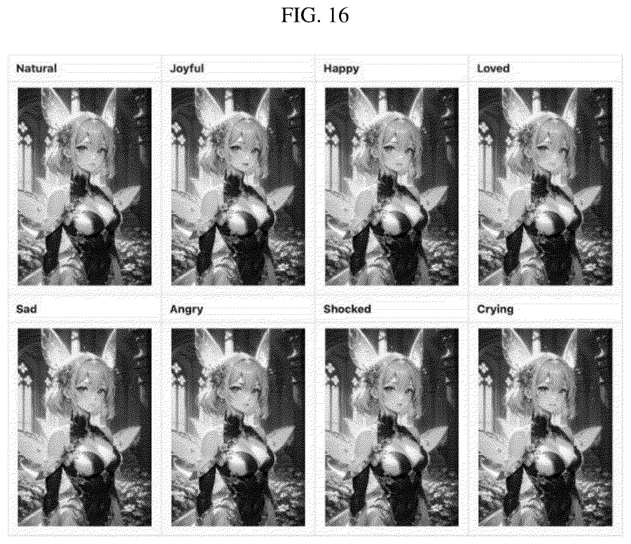

FIG. 16 illustrates an implementation example of emotion images corresponding to emotions according to some example embodiments. The example embodiment of FIG. 16 shows emotion images of the same AI character corresponding to eight emotions, respectively, such as ‘Natural’ that represents a calm and balanced feeling without a particularly strong or intense feeling, ‘Shocked’ that represents a feeling of great surprise in an unexpected situation or a surprising event, ‘Loved’ that represents a state of experiencing a positive emotion in a relationship while feeling warmth, affection, and a sense of belonging, ‘Crying’ that represents a state in which tears flow due to a strong emotion, such as sadness, emotion, and frustration, ‘Joyful’ that represents a state of feeling joy and satisfaction with a lively and happy emotion, ‘Sad’ that represents a state of feeling down and experiencing a heavy emotion due to a sense of loss or loneliness, ‘Angry’ that represents a feeling of strong displeasure when an unsatisfactory situation or an injustice occurs, and ‘Happy’ that represents a state of being with satisfaction and a positive emotion and a feeling of being bright and full of energy.

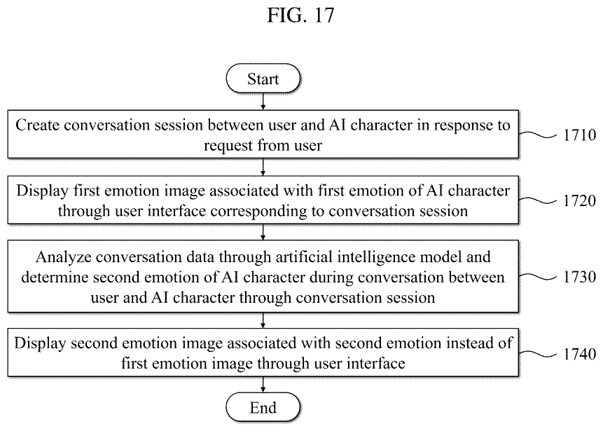

FIG. 17 is a flowchart illustrating an example of a service method according to some example embodiments. The service method, according to some example embodiments, may be performed by the service system 300 that is implemented through at least one computer device. Here, each of the at least one computer device may correspond to the computer device 200 described above with reference to FIG. 2. At least one processor included in the at least one computer device may be implemented to execute a control instruction according to a code of at least one computer program or a code of an operating system (OS) included in a memory. Here, the at least one processor may operate in response to the control instruction provided from the code, and may control the service system 300 such that the service system 300 may perform operations 1710 to 1740 included in the method of FIG. 17.

In operation 1710, the service system 300 may create a conversation session between a user and an AI character in response to a request from the user. Here, the service system 300 may create the conversation session between the AI character and the user corresponding to selection information based on the selection information of the AI character included in the request from the user. A plurality of AI characters may be present in a service provided from the service system 300, and the user may select a single AI character from among the plurality of AI characters and may request a conversation. In some example embodiments, the selection information may be included in the request, and the service system 300 may create the conversation session by linking the AI character corresponding to the selection information included in the request with the user.

In operation 1720, the service system 300 may display a first emotion image associated with a first emotion of the AI character through a user interface corresponding to the conversation session. For example, the first emotion may include an emotion set as default for the AI character. As another example, the first emotion may include an emotion determined by the profile of the AI character. In some example embodiments, in response to the change in the profile of the AI character, the first emotion of the AI character may also be changed. Also, the user interface may include a chatroom in which instant messages transmitted and received between the user and the AI character are displayed. In some example embodiments, the service system 300 may display the first emotion image in the background of the chatroom.

In operation 1730, the service system 300 may analyze conversation data through an artificial intelligence model and may determine a second emotion of the AI character during conversation between the user and the AI character through the conversation session. For example, the service system 300 may create a first response corresponding to a first message of the user through the artificial intelligence model and may determine an emotion corresponding to the first response as a second emotion. In some example embodiments, every time the user inputs (and/or transmits) a message, the second emotion may be determined. Also, even for the same first message, different emotions may be determined as second emotions depending on the content of messages transmitted and received through the conversation session. As another example, the service system 300 may analyze at least a portion of messages transmitted and received through the conversation session through the artificial intelligence model and may determine the second emotion. In some example embodiments, without a message input (and/or transmitted) from the user, the second emotion may be determined periodically or to correspond to a message of the AI character.

In operation 1740, the service system 300 may display a second emotion image associated with the second emotion instead of the first emotion image through the user interface. This second emotion image may also be displayed through the background of the chatroom provided as the user interface.

In some example embodiments, the service system 300 may retrain the artificial intelligence model for each user using user-specific conversation history. For example, when the service system 300 utilizes an artificial intelligence model that is internally created and utilized, the service system 300 may operate different versions of the artificial intelligence model for each user. In some example embodiments, the service system 300 may determine the second emotion by utilizing the artificial intelligence model retrained for the user. In some example embodiments, creation of the AI character may also be achieved using the artificial intelligence model retrained for the user.

Meanwhile, the service system 300 may analyze the relationship between the user and the AI character using the artificial intelligence 340, and may automatically create and provide various derivative images for the AI character based on the analyzed relationship. For example, the service system 300 may automatically create a new relationship image for the AI character and display the same as the relationship between the user and the AI character develops (e.g., as intimacy increases). For example, the service system 300 may analyze messages transmitted and received through the conversation session set between the user and the AI character using the artificial intelligence 340, and may visualize the change in the emotional relationship between the user and the AI character as an image based on the analysis results. As the user and the AI character become intimate (e.g., as intimacy increases), the AI character's facial expression, action, pose, and/or background may change.

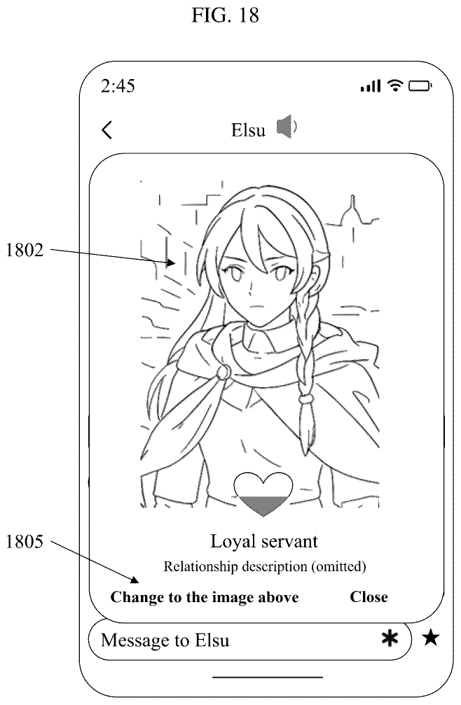

FIG. 18 illustrates an example in which a new relationship image is automatically created and displayed according to the change in relationship in some example embodiments. While the user is having a conversation with the AI character through a chatroom, the service system 300 may detect the change in relationship between the user and the AI character. Here, when the change in relationship is detected, the service system 300 may automatically create a new relationship image 1802 corresponding to the changed relationship using the artificial intelligence 340, and may display the automatically created relationship image 1802 in a pop-up form as in the example embodiment of FIG. 18. When the user selects to change the image (e.g., by pressing or touching the prompt 1805), the new relationship image 1802 may be displayed by replacing the existing image (image of the AI character 1204 displayed in the background of the chatroom) of the AI character.

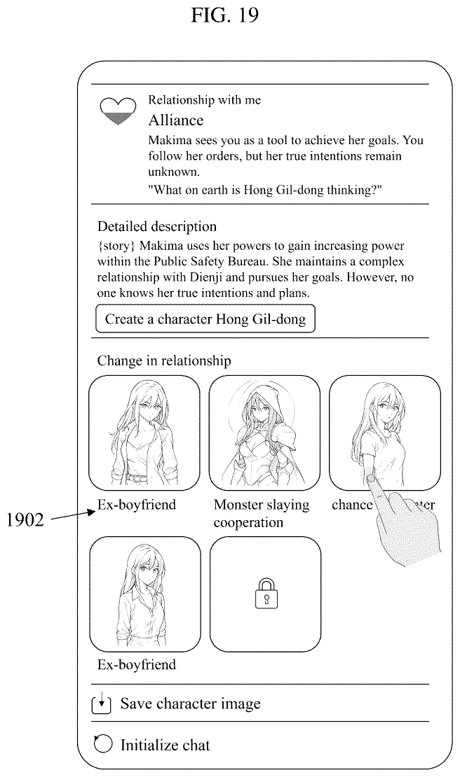

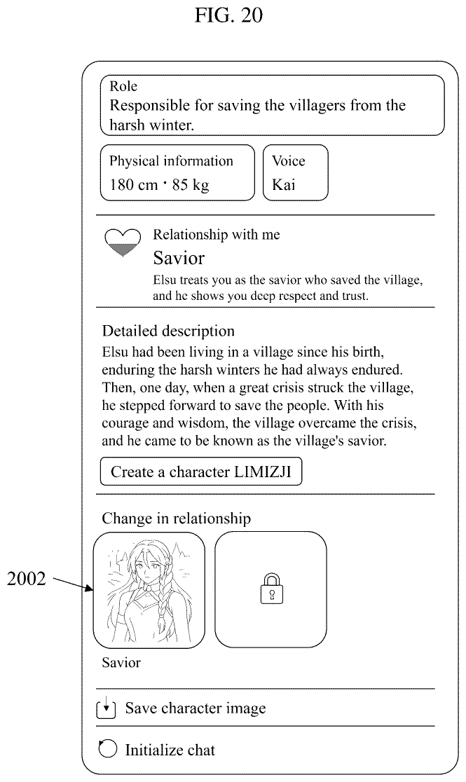

FIGS. 19 and 20 illustrate examples of displaying relationship images through the profile of an AI character according to some example embodiments. FIGS. 19 and 20 illustrate profiles of different AI characters, respectively. The profile of the AI character may include contents input from the user or automatically set, and may display the history of relationship images 1902 that are dynamically created based on the change in relationship. The user may view the relationship images once created again on the profile of the AI character, and may select and use a desired relationship image 2002 as a default image of the AI character (e.g., image displayed in the background in the chatroom).

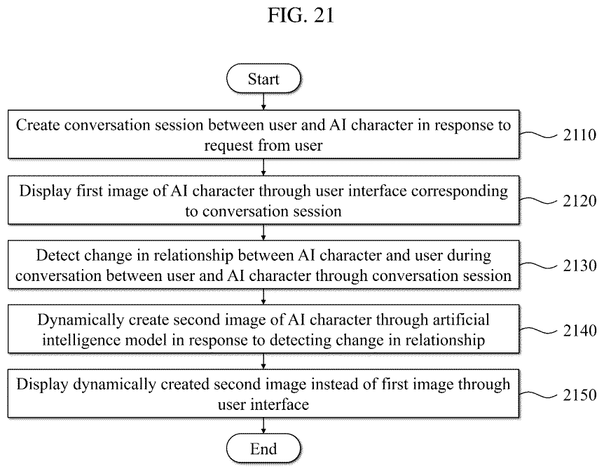

FIG. 21 illustrates an example of a service method according to some example embodiments. The service method, according to some example embodiments, may be performed by the service system 300 that is implemented through at least one computer device. Here, each of the at least one computer device may correspond to the computer device 200 described above with reference to FIG. 2. At least one processor included in the at least one computer device may be implemented to execute a control instruction according to a code of at least one computer program or a code of an operating system (OS) included in a memory. Here, the at least one processor may operate in response to the control instruction provided from the code and may control the service system 300 such that the service system 300 may perform operations 2110 to 2150 included in the method of FIG. 21.

In operation 2110, the service system 300 may create a conversation session between the user and the AI character in response to a request from the user. Here, the service system 300 may create the conversation session between the AI character and the user corresponding to selection information based on the selection information of the AI character included in the request from the user. A plurality of AI characters may be present in a service provided by the service system 300, and the user may select a single AI character from among the plurality of AI characters and may request a conversation. In some example embodiments, the selection information may be included in the request, and the service system 300 may create the conversation session by linking the AI character corresponding to the selection information included in the request with the user.

In operation 2120, the service system 300 may display a first image of the AI character through a user interface corresponding to the conversation session. Here, the user interface may include a chatroom in which instant messages transmitted and received between the user and the AI character are displayed. In some example embodiments, the service system 300 may display the first image in the background of the chatroom.

In operation 2130, the service system 300 may detect the change in the relationship between the AI character and the user during conversation between the user and the AI character through the conversation session. The detection of the change may be achieved through a qualitative method and/or a quantitative method. Initially, as the quantitative method, the service system 300 may detect the change in the relationship based on at least one of the number of conversation turns between the user and the AI character, the number of messages transmitted and received through the conversation session, and the length of messages transmitted from the user. As the qualitative method, the service system 300 may analyze at least a portion of messages transmitted and received through the conversation session through the artificial intelligence model, and may detect the change in the relationship between the user and the AI character. In some example embodiments, the service system 300 may detect the change in the relationship between the user and the AI character through at least one of the user's speech style and the context of conversation between the user and the AI character acquired by analyzing at least a portion of the messages transmitted and received through the conversation session through the artificial intelligence model. In some example embodiments, both the quantitative method and the qualitative method may be utilized. For example, after computing first intimacy according to the quantitative method and second intimacy according to the qualitative method, the change in the relationship may be detected based on final intimacy that is computed through the sum (or weighted sum) between the first intimacy and the second intimacy.

In operation 2140, the service system 300 may dynamically create a second image of the AI character through the artificial intelligence model in response to detecting the change in the relationship. For example, the service system 300 may create an image corresponding to the changed relationship as the second image using the artificial intelligence model. In some example embodiments, the service system 300 may create the image corresponding to the changed relationship as the second image using the artificial intelligence model and, here, may create the second image by further using at least a portion of the messages transmitted and received through the conversation session.

In operation 2150, the service system 300 may display the dynamically created second image instead of the first image through the user interface. Through the change (change in facial expression, action, pose, background, etc.) of the image of the AI character displayed through the user interface, the user may more easily identify that the relationship between the user and the AI character has changed, and may experience the progression of story in the interaction with the AI character.

In some example embodiments, the service system 300 may display the history of relationship images dynamically created for each change in the relationship through the profile of the AI character. Displaying the history of relationship images through the profile of the AI character is described above with reference to FIGS. 19 and 20.

According to some example embodiments, it is possible to provide an AI character creation method and system that may create an AI character capable of interacting with a user with minimal input from the user.

Also, according to some example embodiments, by determining an emotion of an AI character through analysis of conversation data between a user and the created AI character and by automatically changing and providing an image of the AI character that reflects the determined emotion, the user may view the AI character express the emotion appropriate to the context of conversation while the user is conversing with the AI character, so it is possible to provide a service method and system that may improve the user's service experience.

Also, according to some example embodiments, by dynamically creating and displaying an image of an AI character that is derived or obtained according to the change in relationship between a user and the AI character, the user may identify with relative ease that the relationship between the user and the AI character has changed, and it is possible to provide a service system and method that allows the user to acquire an experience similar to the progression of a story through interaction with the AI character.

The systems or the apparatuses described above may be implemented using hardware components, software components, and/or a combination thereof. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of the processing device is used in singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied in any type of machine, component, physical equipment, virtual equipment, a computer storage medium or device, or in a propagated signal wave capable of providing instructions or data to or being interpreted by the processing device. The software also may be distributed over network coupled computer devices so that the software is stored and executed in a distributed fashion. The software and data may be stored by one or more computer readable storage mediums.

The methods, according to some example embodiments, may be configured in the form of program instructions performed through various computer methods and recorded in non-transitory computer-readable media. The media may include, alone or in combination with program instructions, data files, data structures, and the like. Here, the media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software. Examples of the program instructions include an advanced language code that may be executed by a computer using an interpreter as well as a machine language code as produced by a compiler.

As described herein, any devices, systems, modules, portions, units, controllers, circuits, and/or portions thereof according to any of the example embodiments, and/or any portions thereof (including, without limitation, the electronic devices 110, 120, 130, and 140, the plurality of servers 150 and 160, the network 170, the processor 220, the communication interface 230, the input/output (I/O) interface 240, the I/O device 250, the user terminals 330, the service server 310, the AI character creation system 320, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), a System-on-Chip (SoC), a programmable logic unit, a microprocessor, an application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments. The processing circuitry may include electrical components such as at least one of transistors, resistors, capacitors, etc. The processing circuitry may include electrical components such as logic gates including at least one of AND gates, OR gates, NAND gates, NOT gates, etc.

In some example embodiments, the service system 300 of FIG. 3 may be applied to machine learning systems including, for example, the artificial intelligence 340. Such machine learning systems may utilize various artificial neural network organizational and processing models, such as convolutional neural networks (CNN), feedforward neural networks (FFN), de-convolutional neural networks, recurrent neural networks (RNN) optionally including long short-term memory (LSTM) units and/or gated recurrent units (GRU), stacked neural networks (SNN), state-space dynamic neural networks (SSDNN), deep belief networks (DBN), generative adversarial networks (GANs), and/or restricted Boltzmann machines (RBM).

Alternatively or additionally, such machine learning systems may include other forms of machine learning models, such as, for example, linear and/or logistic regression, statistical clustering, Bayesian classification, decision trees, dimensionality reduction such as principal component analysis, and expert systems; and/or combinations thereof, including ensembles such as random forests. Such machine learning models may be used to provide various services and/or applications, for example, an image classification service, a user authentication service based on bio-information or biometric data, an advanced driver assistance system (ADAS) service, a voice assistant service, an automatic speech recognition (ASR) service, or the like, and may be executed by other electronic devices.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. An artificial intelligence (AI) character creation method implemented by at least one computer device, the at least one computer device including at least one processor, and the AI character creation method comprising:
receiving, by the at least one processor, image data for creation of an AI character;
setting, by the at least one processor, a group of the AI character; and
creating, by the at least one processor, the AI character based on the image data and the group of the AI character.

2. The AI character creation method of claim 1, wherein the receiving the image data comprises providing a user interface including a first function for uploading the image data and a second function for inputting a value for one or more items of a plurality of items related to the creation of the AI character.

3. The AI character creation method of claim 2, wherein the receiving the image data further comprises:
creating a plurality of character appearances for the AI character based on the image data uploaded using the first function; and
providing the plurality of character appearances through the user interface, and setting one of the plurality of character appearances as an appearance of the AI character.

4. The AI character creation method of claim 3, wherein the creating the AI character further comprises creating the AI character based on the appearance of the AI character.

5. The AI character creation method of claim 2, wherein the user interface further includes a third function for selecting one of a plurality of character voices related to the creation of the AI character.

6. The AI character creation method of claim 2, wherein the plurality of items includes at least one mandatory item that is mandatorily input by a user and a plurality of optional items optionally input by the user, and
the AI character creation method further comprises automatically setting, by the at least one processor, a second value of an optional item that is not input by the user, wherein the second value is set based on the image data and a first value of the at least one mandatory item that is input by the user, the second value being set using the second function.

7. The AI character creation method of claim 6, wherein the at least one mandatory item includes at least one of a privacy setting of the AI character, a character name, or a description indicative of the AI character, and
the plurality of optional items include at least two of a first line that is stated by the AI character, a detailed description of the AI character, and a description of a relationship between the user and the AI character.

8. The AI character creation method of claim 6, wherein the creating the AI character further comprises creating the AI character further based on the first value input by the user and the second value that is automatically set.

9. The AI character creation method of claim 1, wherein the setting the group comprises setting the group of the AI character based on the image data.

10. The AI character creation method of claim 1, wherein the creating the AI character further comprises:
creating a prompt for the creation of the AI character based on the image data and the group of the AI character; and
creating the AI character that is configured to interact with a user by providing a personality to the AI character using an artificial intelligence model, the personality being provided through the prompt.

11. The AI character creation method of claim 1, further comprising processing, by the at least one processor, interaction between the AI character that is created and a user.

12. The AI character creation method of claim 11, wherein the interaction includes a conversation based on at least one of voice or an instant message between the AI character and the user.

13. The AI character creation method of claim 1, wherein the group of the AI character is associated with a genre, and the AI character is associated with the genre.

14. A non-transitory computer-readable recording medium storing a computer program which when executed by the at least one processor configures the at least one computer device to implement the artificial intelligence (AI) character creation method of claim 1.

15. An artificial intelligence (AI) character creation system implemented using at least one computer device, wherein the at least one computer device includes at least one processor, and
the at least one processor configures the at least one computer device to,
receive image data for creation of an AI character,
set a group of the AI character, and
create the AI character based on the image data and the group of the AI character.

16. The AI character creation system of claim 15, wherein, to receive the image data, the at least one processor configures the at least one computer device to provide a user interface including a first function for uploading the image data and a second function for inputting a value for one or more items of a plurality of items related to the creation of the AI character.

17. The AI character creation system of claim 16, wherein the plurality of items include at least one mandatory item that is mandatorily input by a user and a plurality of optional items optionally input by the user, and
the at least one processor configures the at least one computer device to automatically set a second value of an optional item that is not input by the user, wherein the second value is based on the image data and a first value of the at least one mandatory item that is input by the user, the second value being set using the second function.

18. The AI character creation system of claim 17, wherein the at least one mandatory item includes at least one of a privacy setting of the AI character, a character name, or a description that is indicative of the AI character, and
the plurality of optional items include at least two of a first line that is stated by the AI character, a detailed description of the AI character, and a description of a relationship between the user and the AI character.

19. The AI character creation system of claim 17, wherein, to create the AI character, the at least one processor configures the at least one computer device to create the AI character further based on the first value input by the user and the second value that is automatically set.

20. The AI character creation system of claim 15, wherein, to create the AI character, the at least one processor configures the at least one computer device to,
create a prompt for the creation of the AI character based on the image data and the group of the AI character, and
create the AI character that is configured to interact with a user by providing a personality to the AI character using an artificial intelligence model, the personality being provided through the prompt.
